(19) United States
(12) Patent Application Publication
(10) Pub. No.: US 2010/0032369 A1
(43) Pub. Date: Feb. 11, 2010

(54) SEWAGE PURIFICATION PLANT AND PROCESS THEREOF

(76) Inventor: Antonio Bertolotto, Borgo San Dalmazzo (Cuneo ) (IT)

Correspondence Address: NIXON & VANDERHYE, PC, 901 NORTH GLEBE ROAD, 11TH FLOOR, ARLINGTON, VA, 22203, US

(21) Appl. No.: 12/518,945

(22) PCT Filed: Dec. 14, 2006
(86) PCT No.: PCT/IT2006/000848

§ 371 Date: Jun. 12, 2009

(51) Int. Cl. C02F 3/28

(52) U.S. Cl. 210/603; 210/194; 210/197; 210/149; 210/195.1

(57) ABSTRACT

Plant and procedure thereof for the purification of sewage that enables the sewage to be purified and energy to be obtained, and at the same time enables a product to be obtained given by the combination of organic residues and fibre filters, appropriate, for example, to supply a plant for breeding earthworms, or for different types of agricultural crop.

The present invention relates to sewage purification plants, with particular reference to sewage deriving from organic waste produced in farms given over to the breeding of farmyard animals, above all sewage consisting of a large liquid component of the type of pig-farm sewage, or agroindustrial sewage, with a high daily production, in the 100-10,000 m³ range, in order to obtain a rapid “dry-liquid” separation virtually without cost and an organic mass to be turned into energy through “biogas energy” anaerobic digestion and that can be used in the agricultural field, above all in energy-requiring crops; thus attaining purification with an economically-positive energy balance that is eco-sustainable, rather than purification that only generates costs and waste to be disposed of.

Conventional plants of the type indicated above treat the sewage in order to eliminate pollutant substances contained in it and to produce an organic mass containing nutrients useful for example for fertilisation purposes, or for the culture of organisms.

For example, treatment plants are known for the purification of sewage and waste water that comprise at least one sedimentation tank in which a mixture of sewage is introduced comprising a solid phase and a liquid phase, said tank being provided with means of filtration capable of intercepting first organic compounds in the solid phase that accumulate on the bottom of the sedimentation tank, and at least one purification channel comprising means of purification capable of purifying said mixture, these means of purification comprising microorganisms that develop an aerobic digestion process.

The present invention aims to produce a plant of the type indicated above, which is more efficient and that affords an economic return with higher operational yield than the yield of plants of the traditional type.

The purification plant according to the present invention, as well as eliminating harmful substances and purifying the sewage, also produces biogas through anaerobic digestion of the organic material concentrated in the solid fraction during one of the sewage treatment phases, in such a manner that part of the biogas produced is employed to supply energy to the plant itself, and provides for the production of a well-stabilised digested product that is still rich in nutrients, which are duly obtained through inoculation of microbes and through the digestion process, to be used in subsequent metabolic humification phases as a preliminary to making possible agricultural, biological and energy-related uses.

The above goals are achieved by a plant presenting the characteristics of the introductory part of claim 1, and further characterised in that said sedimentation tank is hermetically sealed from the external environment through covering means, and presents means of purification including anaerobic microorganisms for the treatment of sewage or of said mixture in an anaerobic environment to produce biogas, said tank also possessing means for the suction and recirculation of said biogas, a flow of which is introduced into said sedimentation tank.

Equally, the above goals are reached according to the invention by a procedure for the purification of sewage formed of a solid/liquid mixture of organic substances, having the characteristics of claim 18.

A further advantage of the purification plant according to the present invention and of the procedure thereof consists in the fact that the organic material of the sewage is completely modified so as to be suitable also for immediate utilisation in the agricultural field without further intermediate treatment. Indeed, the means of filtration of the plant include fibre filters that, combined with the solid phase separated from the liquid phase of the sewage during the digestion process in the methane-producing anaerobic phase, constitute a biomass that, once it is pre-composted, may be used for example in breeding earthworms. In its turn, the liquid phase deriving from the purification of the sewage becomes a nutrient liquid for special hydroponic crops or, for example, for fertilising irrigation.

A further advantage deriving from the sewage purification plant and from the procedure thereof according to the present invention consists in the fact that large daily quantities of sewage can be purified, for instance in the 100 to 10,000 m³ range, whose management may easily the programmed thanks to the characteristics of said plant and the procedure thereof, including the fact that each sedimentation tank is destined for a specific working day of the week.

Further goals, characteristics and advantages of the present invention will be clear from the detailed description that follows and from the attached drawings, provided as a simple explanatory example without limiting intent, in which:

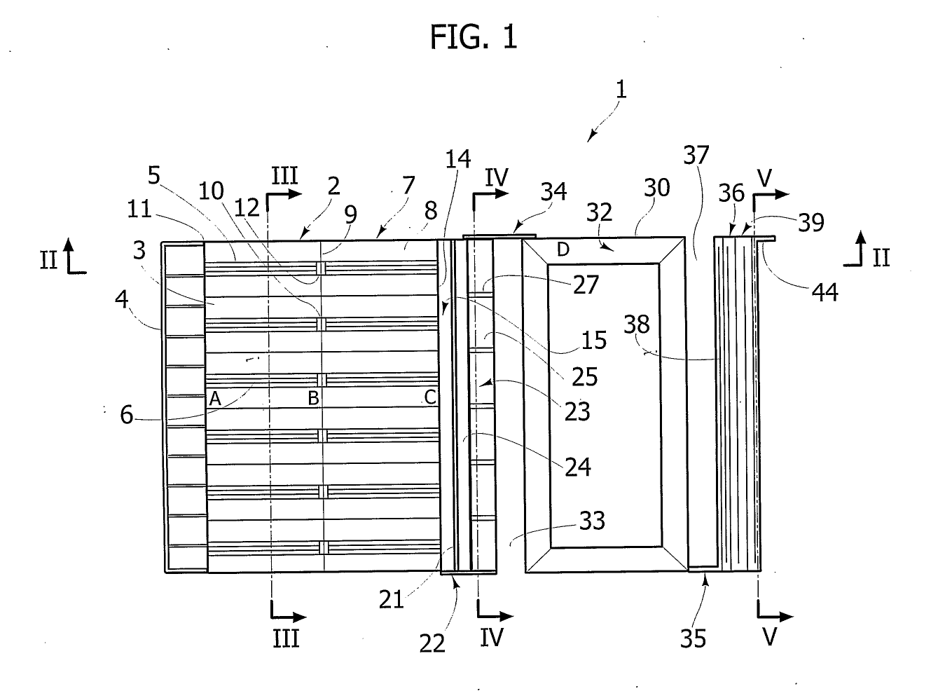

FIG. 1 is a plan view of the entire plant that carries out the procedure in question;

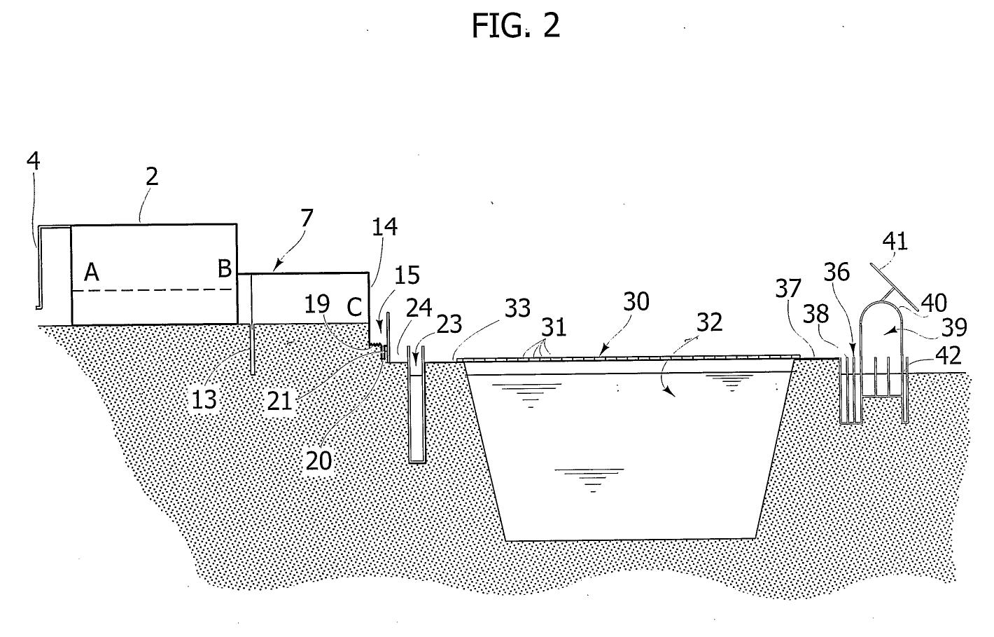

FIG. 2 is a section along the line II-II in FIG. 1;

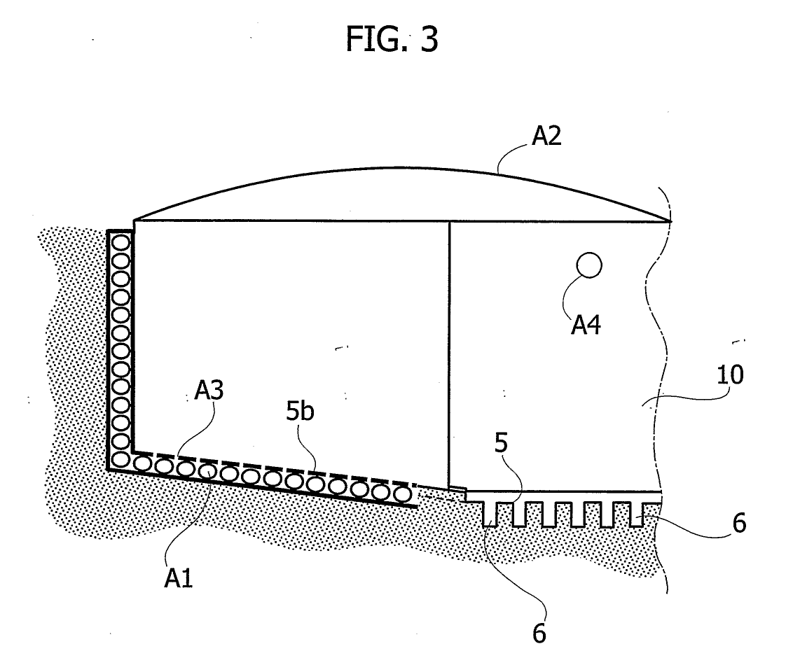

FIG. 3 is an enlarged partial section along the line III-III of FIG. 1;

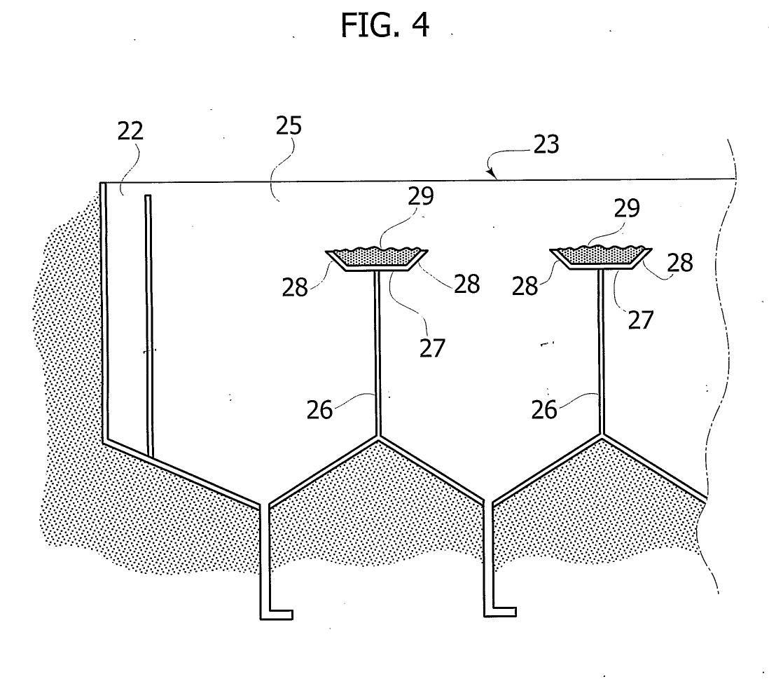

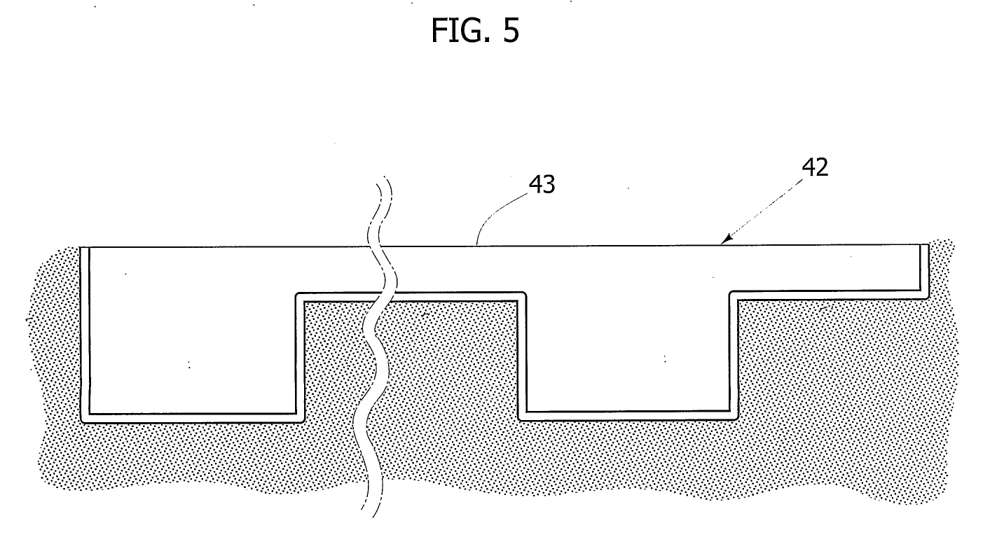

FIGS. 4 and 5 are enlarged partial sections along the lines IV-IV and V-V of FIG. 1.

With regard to the above figures, number 1 indicates a plant for the purification of sewage formed of a solid/liquid mixture of organic substances. As FIG. 1 shows, it comprises a first and a second series of tanks 2, 7, both formed of a vertical (with reference to the figure) succession of substantially rectangular tanks 3, 8. The tanks belonging to the same series are united in correspondence with their longer sides, whereas the tanks belonging to different series and that occupy the same position within the series, are in reciprocal contact in correspondence with their shorter sides.

For simplicity of description, an overall layout of the tanks 3, 8 may be determined that forms a matrix with six lines and two columns. This characteristic of the layout is only employed as an example and is thus not essential for the purpose of the invention. Indeed, it is possible to provide for a different number and arrangement of tanks 3, 8 without thereby departing from the purposes of the invention.

The said layout presents a long side A (on the left-hand side in FIG. 1) for introduction of the sewage. Side A includes, in correspondence with each tank 3, pipelines 4 for the supply of sewage or waste water, and entrance doors 11 that regulate the introduction of said sewage. The sewage is introduced into the pipelines 4 and subsequently comes into correspondence with interstitial spaces (not shown) practised along the horizontal (with reference to FIG. 1) walls of the tanks 3, 8 and whose upper side is open, in such a manner that the sewage may discharge into the tanks 3, 8 by overflowing.

The tanks 8 of the second series 7 have a capacity proportional to the percolating flow and present a different longitudinal extension (see FIG. 1) and a different height (see FIG. 2) than the tanks 3 of the first series 2.

As shown in FIG. 1, each series 2, 7 comprises six tanks. Although not restrictive with regard to the purpose of the invention, this arrangement has been adopted in order to optimise and facilitate plant management: the first five tanks of each series 2, 7 comprise respective chambers to be filled in the first five days of the week, whereas the last tank comprises a reserve chamber that enables any peaks of maximum utilisation of the plant to be handled.

As shown in FIG. 3, the bottom 5 of the tanks 3, 8 presents a flat central region that crosses the entire long side of the tanks 3, 8, and two regions 5b, respectively at either side of the flat region 5, that slope slightly downwards towards it.

It also presents a series of small flow channels 6, that run for the entire length of the tanks 3, descending slightly as their distance from the side A increases, and on which filtering fibres are arranged. The small channels 6 of the tanks 3, 8 belonging to the same line in said layout are in reciprocal communication and flow out to the external part of the layout, in correspondence with the long side C opposite the long side A. It is important to note that the flow bringing the sewage into the tanks 3, 8 from the interstitial spaces described above, takes place along a direction perpendicular to the longitudinal extension of the small channels 6, in such a manner as to create movement in the sewage that favours the filtering process.

Furthermore, the tanks belonging to the same row can be connected one to the next by activating gates 10 that are either pivoted horizontally or sliding, arranged on the dividing walls of the tanks in the same row in the layout, in correspondence with the flat region 5. A further opening 12, for example of the lock-gate type, that may be operated automatically or manually and that slides inside an appropriate underground seating, is situated alongside the gates 10.

The first and the second series of tanks have the function of allowing the organic substances in the solid phase of the sewage to sediment and of performing a filtering action through said fibres. The liquid phase collects in the small channels 6 and, through gravity, reaches a channel 15, situated beyond the side C of the layout of the first and second series of tanks 2, 7. The small channels 6 flow out towards the outside of the series of tanks 2, 7 into the channel 15, that is circumscribed, on one side, by the walls 14 comprising the side C of said layout.

Each line of the layout is provided with a covering A2 that hermetically seals the inside of the tanks 3, 8 from the external environment so as to comprise a digester/gas producing chamber that encloses an oxygen-poor environment and that, during operation of the plant, becomes saturated with biogas, as will be described below.

The covering A2 is restricted to the edges of the tanks 3, 8 in a flexible and inflatable manner and is elastic such that it can inflate due to the pressure of biogas produced, and thus adapt the capacity of the chamber that it constitutes to the volume of liquid contained in it.

Thanks to the adoption of a sealed cover, inside the tanks 3, 8 an environment virtually free of oxygen is created within which the appropriate conditions come about for the development of anaerobic digestion processes of the organic substances sedimented inside the tanks 3, 8.

The anaerobic digestion processes of the organic materials consist in the biochemical conversion in the absence of oxygen of complex organic substances by means of anaerobic microorganisms, such as for example bacteria, converting them into simpler organic substances and at the same time producing biogas. In order to create the optimum conditions for these processes, the tanks 3, 8 have bottom and walls heated by pipes arranged in a serpentine manner through which hot water flows, and that are indicated with A1 in FIG. 3. The temperature inside the chamber constituted by the tanks 3, 8 fitted with coverings A2 is regulated by a programming computer (PLC) and is selected such as to guarantee a population of mesophilic bacteria capable of favouring the rapid production of methane from the sewage.

The covering A2 is made of impermeable material appropriate to act as a tank to contain the biogas as this is produced. The biogas remains between the covering A2 and the sewage and is extracted by suction with an appropriate system through a channel A4, shown in FIG. 3. A specific by-pass system situated on the channel A4 enables the malodorous air loaded with oxygen to be intercepted when the process is started and to be conveyed to a specific biofilter.

Sewage recirculation pipes (not shown) flow into the layout of the series of tanks 2, 7 in correspondence with the side A; these pipes take up the sewage in correspondence with the tanks 8 and, after having heated it, return it into the tanks 3, 8 to favour micro-bacterial transmigration.

The bottom of the channel 15 is lower than the bottom of the tanks 3, 8 and presents a first stretch 19 in correspondence with the region adjacent to the wall 14, fitted with a series of small humps, and a second stretch 20 including a further small channel 21, on which further fibre filters are arranged. The bottom of the channel 15 runs slightly downwards so as to convey the liquid phase that has discharged from the second series of tanks 7, to the lower extremity of the channel 15 (with reference to FIG. 1), which is connected to an oxygenation channel 22 (shown in FIG. 1) through a narrow opening (not shown).

The liquid phase that has come out of the tanks 2, 7 also includes aerobic microorganisms that feed on the organic material forming an insoluble sludge that can be separated through conventional physical means. These aerobic microorganisms require a larger quantity of oxygen than that present inside said liquid phase. The oxygenation channel 22 includes means to oxygenate the liquid, such as for example oxygenating wheels of the bio-roller type, that are capable of providing the oxygen required for the survival of these micro-organisms. The oxygenation channel 22 extends perpendicular to the first channel 15 and reaches a settling tank 23. The upper edges of the walls of the oxygenation channel 22 are situated above the respective edges of the settling channel, in order to enable the overflow of liquid from the oxygenation channel 22 into the settling tank 23. The first channel 15 is separated from the settling tank by a service passage 24. The settling tank 23 comprises a series of compartments 25 arranged in succession along a direction parallel to the first channel 15, and at progressively lower levels as they become more distant from the oxygenation channel 22. The compartments 25 present an inclined bottom to enable the liquid to overflow from one compartment into another. These compartments may be fitted with mirrors or lenses (not shown) in order to guide the sun's rays onto the liquid and favour activity of photosynthetic micro-organisms that digests floating oily substances.

As is shown in FIG. 4, the compartments 25 are separated by walls 26 on each of which rests a small terrace 27 with banks 28, capable of receiving filters 29; furthermore, each compartment 25 may be fitted with a further oxygenating wheel (not shown). The filters 29 are capable of separating from the liquid phase the organic compounds that have been generated through the digestion process performed by said aerobic microorganisms. The last of the compartments 25 is fitted with a small tank in which is positioned, immersed, the tube of a pump that draws the liquid into tubing 30 fitted with nozzles 31. The tubing 30 is arranged above an edge D of a settling tank 32, with respect to which the tubing 30 extends parallel. The tubing 30 is capable of causing the liquid phase to enter the basin 32 in the form of drops but without nebulisation. Between the basin 32 and the settling tank 23 there is a service passage 33.

A channel 34 extends perpendicularly from the settling tank 23 to the basin 32 and presents upper edges that are higher than those of the basin 32, so that should said pump fail to operate, the liquid may equally reach the basin 32 by overflowing from the connecting channel 34.

The basin 32 possesses appropriate dimensions to enable a specific accumulation of liquid originating from the parts of the plant 1 described above, in consequence enabling the liquid to rest for a certain period inside the basin without having to block the flow upstream from it. The basin 32 is also provided with bottom and walls that are waterproofed employing appropriate material.

The basin is connected to a discharge channel 35 that links it to a channel 36, from which said basin 32 is separated by a further service passage 37. The liquid in the discharge channel 35 discharges into the channel 36 by overflowing, since the channel 35 presents upper edges at an appropriate height.

The serpentine arrangement of the channel 36 is formed by walls 38 that are arranged inside external perimeter walls, reciprocally arranged in such a way as to achieve a tortuous and serpentine flow. On the bottom of the channel 36, further means of oxygenation are situated, formed of wheels fitted with oxidative blades powered by a solar panel (not shown), for further oxygenation of the liquid. The channel 36 flows directly into a second serpentine channel 39, of lesser depth, and provided with a hydroponic crop (for example EICHORNIA CRASSIPES) for further purification of the liquid.

The serpentine channel 39 is also fitted with a covering of the greenhouse type in synthetic material 40, with a solar panel plant 41 to maintain an ideal temperature inside it.

Lastly, through an appropriate pipeline 44, the liquid may be directed toward possible uses in the agricultural field or directly discharged into a water course.

According to a further embodiment it is also possible to install a series of pipelines (not shown) linked to the basin 32 in order to input a quantity of the liquid present in the channel 39 that is at an appropriate temperature into the basin on a closed-cycle basis, facilitating the purification process that takes place in said basin 32.

Depending on the specific case, it is possible to provide for a further channel 42, with flat bottom and raised areas at intervals 43 provided with filters (see FIG. 5) for further treatment, if required, of the liquid before its final disposal.

In all the phases the sewage is bio-activated with specific microbial loads (bacteria and moulds) properly selected according to the type of sewage and the type of aerobic or anaerobic phase.

Operation of the plant described above comes about as follows.

A specific quantity of sewage is introduced through the opening 11 practised on side A of the layout shown previously. With particular reference to the embodiment described above, for each working day of the week, a precise quantity of sewage is supplied to one of the lines of the layout consisting of the first and second series of tanks 2, 7, each of which is dedicated to a different day of the working week. When the material is introduced, sewage is discharged from tank 3 to tank 8 of said line of the layout, producing a filtering and percolation effect. Furthermore, each time the tanks 3, 8 are filled, the air present in them is sucked out to create an environment that is completely free of oxygen.

The tanks 3 and the tanks 8 perform a dual action of filtering and digesting the sewage.

Indeed, the solid phase present in the sewage is intercepted by the means of filtration formed of fibre inserts arranged in correspondence with the small channels 6, such that substantially only the liquid phase may flow out of the layout formed by the first and second series of tanks 2, 7 through the said small channels 6. The solid phase, on the contrary, accumulates inside the tanks 3, 8 and sediments on the bottom.

In the chambers comprised by the tanks 3, 8 that are hermetically sealed from the external environment and lacking in oxygen, optimal conditions are created for the development of anaerobic digestion processes of the organic substances contained in them by anaerobic microorganisms. These anaerobic digestion processes lead to the production of biogas that consists of 50-70% of methane, the remainder being above all carbon dioxide.

The biogas produced is sucked out and part of it is blown back into the tanks 3, 8 through the diffusers A3 situated on the bottom 5. The flow of recirculated biogas has first and foremost the function of creating an environment saturated with biogas in order to favour the production, by anaerobic digestion, of biogas. The biogas is further enriched with anaerobic microorganisms such as to ensure continuation of the anaerobic digestion processes.

The remainder of the biogas that is not returned to the tanks 3, 8 is used as a source of energy, and is thus exploited to power the various mechanical means used for operation of the plant and to obtain the energy necessary to heat the sewage that is contained in the tanks 3, 8 or that passes through the recirculation pipelines.

Furthermore, diffusion of the biogas from the bottom 5 enables the organic substances that have accumulated there to be shifted, thus avoiding the partial blockage of the small channels 6 that would block the flow of the liquid phase towards the subsequent sections of the plant. However, should the small channels 6 become blocked, the gates 10, 12 can be activated in such a manner as to enable the gradual passage of the liquid phase from the tanks 3 to the tanks 8 and, in the same way, the gates 16 can be moved to enable the gradual passage from the tanks 8 to the first channel 15. As described above, the environment inside the tanks 3, 8 is heated through hot water pipes A1 that surround the bottom and walls of the tanks 3, 8.

Through regulation of the internal temperature managed by the PLC, the total mesophytic bacterial load present in the tanks 3, 8 may be regulated.

Furthermore, through the recirculation pipelines it is possible to re-introduce part of the outgoing sewage leaving the layout of the first and second series of tanks 2, 7 into the tanks 3 to enable the optimal conditions for the development of anaerobic digestion processes to be achieved more rapidly.

The liquid that passes along the channel 15 is subject to a further sedimentation and filtration process in the stretch 19 that is provided with humps and in correspondence with the small channel 21 including further fibres acting as a filter.

The channel 15 has the function of intercepting the solid phase remaining in the liquid that was not filtered in the layout of tanks 3, 8.

The solid organic substances accumulated up to now present optimal characteristics to be utilised as a nutritious agricultural product for different types of cultivation, such as for example for breeding earthworms.

The liquid phase continues along its route inside the oxygenation channel 22, in which, through pumps injecting air and oxygenation wheels, it is provided with the oxygen necessary for proliferation of the aerobic bacterial flora that feeds on the organic material forming an insoluble sludge, which can be separated with conventional mechanical means.

From the oxygenation channel 22, the liquid enters the first compartment 25 of the settling tank 23 by overflowing and, thanks to the inclination of the tank 23, passes in succession, again by overflowing, through all the compartment 25. In passing from one compartment to the next the liquid becomes separated from the sludge produced by the bacterial flora and from any solid substances still present by means of the small terraces 27 that slow the flow of liquid so as to enable the filters 29 to perform a further filtering action.

Once the liquid reaches the last compartment, it is taken up forcibly by a pump into the tubing 30 and through the nozzles 31 enters the basin 32 as drops. Separation of the liquid into drops enable its efficient oxygenation that also continues when the liquid is collected in the basin 32 in correspondence with the free surface facing outwards.

The liquid remains in the basin 32 for several days, undergoing an aerobic process operated by aerobic bacterial flora in correspondence with the region having a free surface, and an anaerobic process at depth useful to liberate organic residues that are still present. In particular, the anaerobic process includes a first phase of hydrolysis in which the molecules present in the liquid are simplified and degraded, and a phase of both acid and alkaline fermentation. These processes are controlled through the introduction, at each phase, of anaerobic and aerobic bacteria and moulds together with natural genetically-unmodified enzymes and coenzymes, so as to accelerate the anaerobic and aerobic digestion processes.

After completion of these processes, the liquid, by overflowing and passing through the connecting channel 35, enters the serpentine channel 36 and further means of oxygenation enrich it with oxygen.

Lastly, the liquid flows into the second serpentine channel 39 with a greenhouse-type covering that is provided with a hydroponic crop for further purification and the assimilation of any mineral particles.

The last safety channel may be utilised, when this makes itself necessary, as a last stage of purification during which various chemical additives can be added and, in particular, clarifying agents are added.

The plant and the procedure thereof just described achieve the above-mentioned goals in an optimal manner, and in particular provide for the purification of sewage or waste water whilst obtaining energy, and at the same time make it possible to obtain a product given by the combination of organic residues and fibres that is appropriate, for example, to feed a plant for breeding earthworms, or for agricultural crops of various types.

Naturally, the principle of the invention holding good, construction details and embodiments may vary with regard to what is described and illustrated as a simple example.

1. Plant for the purification of sewage formed of a solid/liquid mixture that includes organic substances, comprising:
at least one sedimentation tank (3, 8) in which said mixture is introduced, said at least one sedimentation tank (3, 8) being provided with means of filtration capable of intercepting at least a part of the solid phase of the mixture that accumulates on the bottom (5) of said at least one sedimentation tank (3, 8);
said plant being characterised in that said at least one sedimentation tank (3, 8) is hermetically sealed from the external environment through covering means (A2) and presents means of purification comprising anaerobic microorganisms for the purification of said mixture in an anaerobic environment to produce biogas, said at least one tank also having means for suction and recirculation (A3/A4) that introduce a flow of said biogas into said at least one sedimentation tank (3, 8).

2. Sewage purification plant according to claim 1, characterised in that it includes at least one purification channel (22, 23, 36, 39) presenting further purification means capable of purifying said mixture, said means comprising aerobic microorganisms that develop an aerobic digestion process.

3. Sewage purification plant according to claim 1, characterised in that said flow of biogas is enriched with anaerobic microorganisms.

4. Sewage purification plant according to claim 1, characterised in that said flow of biogas is introduced from one or more lower zones (5) of said at least one sedimentation tank (3, 8) so as to collide with said mixture.

5. Sewage purification plant according to claim 4, characterised in that said flow of biogas is introduced from the bottom (5) of said at least one sedimentation tank (3, 8).

6. Sewage purification plant according to claim 1, characterised in that said at least one sedimentation tank (3, 8) is fitted with means to regulate the internal temperature.

7. Sewage purification plant according to claim 6, characterised in that said regulation means comprise pipes (A1) through which a heating fluid passes and surrounding at least a part of said at least one tank (3, 8).

8. Sewage purification plant according to claim 1, characterised in that said covering means comprises an upper wall (A2) floating on said mixture.

9. Sewage purification plant according to claim 1, characterised in that said means of filtration comprise fibres.

10. Sewage purification plant according to claim 1, characterised in that said at least one tank (3, 8) presents on the bottom (5) pipes (6) provided with filter elements and communicating with said at least one purification channel (22, 23, 36, 39).

11. Sewage purification plant according to claim 2, characterised in that said aerobic microorganisms of said at least one purification channel (22, 23, 36, 39) produce sludge.

12. Sewage purification plant according to claim 2, characterised in that said at least one purification channel (22, 23, 36, 39) present means of oxygenation capable of enriching said mixture with oxygen.

13. Sewage purification plant according to claim 2, characterised in that it includes an open basin (32) that acts as an accumulation reservoir within which said mixture may be left to settle in fluid communication with said at least one purification channel (22, 23, 36, 39).

14. Sewage purification plant according to claim 2, characterised in that said at least one purification channel includes a channel (39) provided with a purifying hydroponic crop.

15. Sewage purification plant according to claim 14, characterised in that said channel (39) presents a substantially serpentine pathway.

16. Sewage purification plant according to claim 1, characterised in that it presents a plurality of said at least one tank (3, 8) arranged according to a matrix layout with lines and columns (2, 7), the tanks belonging to the same line being beneath the same covering (A2).

17. Sewage purification plant according to claim 16, characterised in that for each working day of the week it presents a specifically dedicated line of said layout (2, 7), the tank (3) of said line that is situated on the first column (2) being the tank into which said sewage is introduced into the plant.

18. Sewage purification plant according to claim 17, characterised in that the tanks belonging to the same line possess different capacities.

19. Procedure for the purification of sewage formed of a solid/liquid mixture that includes organic substances, comprising:
a filtration and sedimentation phase of at least part of the solid phase of the mixture;
said procedure being characterised in that said sedimentation and filtration phase comes about within at least one chamber hermetically sealed from the outside into which the sewage is introduced, and including an anaerobic digestion process of the organic substances contained in said at least one chamber by anaerobic microorganisms in order to produce biogas.

20. Procedure for the purification of sewage according to claim 19, characterised in that it includes a phase of purifying the mixture that provides for an aerobic digestion of the organic substances by aerobic microorganisms.

21. Procedure for the purification of sewage according to claim 19, characterised in that said filtration and sedimentation phase includes suctioning out said biogas produced by said anaerobic microorganisms and introducing a flow of said biogas into said at least one chamber.

22. Procedure for the purification of sewage according to claim 21, characterised in that said flow of biogas is enriched with anaerobic microorganisms.

23. Procedure for the treatment of sewage according to claim 19, characterised in that said sedimentation and filtration phase comes about at a temperature controlled through means to regulate the temperature.

24. Procedure for the treatment of sewage according to claim 20, characterised in that said purification phase includes the oxygenation of said mixture through means of oxygenation.

25. Procedure for the purification of sewage according to claim 19, characterised in that, for each working day of the week, a specifically dedicated chamber is provided.
